(19) United States
(12) Patent Application Publication
(10) Pub. No.: US 2017/0298195 A1
(43) Pub. Date: Oct. 19, 2017

(54) COMPOSITIONS SUITABLE FOR USE IN THE VULCANIZATION OF RUBBER

(71) Applicant: RUBBER NANO PRODUCTS (PROPRIETARY) LIMITED, Port Elizabeth (ZA)

(72) Inventors: Robert Michael BOSCH, Port Elizabeth (ZA); Damian WILLIAMS, Port Elizabeth (ZA)

(73) Assignee: RUBBER NANO PRODUCTS (PROPRIETARY) LIMITED, Port Elizabeth (ZA)

(21) Appl. No.: 15/512,241

(22) PCT Filed: Sep. 18, 2015
(86) PCT No.: PCT/IB2015/057198

§ 371 Date: Mar. 17, 2017

(30) Foreign Application Priority Data
Sep. 19, 2014 (GB) 1416603.7

(51) Int. Cl. C08J 3/24; C08K 5/47; C08K 5/40

(52) U.S. Cl. CPC C08J 3/242; C08K 5/40; C08K 5/47

(57) ABSTRACT

The present invention provides for a composition which is suitable for use in the vulcanization of rubber, and a process for producing the composition. The composition comprises a salt of a vulcanization accelerator which is selected from a group of accelerator classes including thiazoles, dithiocarbamates, dithiophosphates, sulfenamides, thiuram sulfides, xanthates, guanidines, aldehyde amines, or combinations thereof; a solid particulate substrate; and a hydrophobic carrier material.

### INTRODUCTION

This invention relates to new materials which are suitable for use as activators in the vulcanization of rubber, and to methods to prepare these materials.

### BACKGROUND

Activators and accelerators play an important part in the vulcanization of rubber, and together with the other components in the specific cure package, the activator and accelerator determines the reaction kinetics of the vulcanization process. The specific activator and accelerator, or blend of these compounds, used in the vulcanization of rubber imparts on the final product the specific properties that are required for the particular intended application.

The accelerator sodium 2-mercaptobenzothiazole (NaMBT) is currently used in the vulcanization of latex rubber. The sodium 2-mercaptobenzothiazole (NaMBT) material currently used in this process is a liquid at room temperature and is very water soluble. The material is also caustic and is therefore difficult to use in solid state rubber mixing.

Furthermore, accelerators of other well-known accelerator classes such as dithiocarmates, thiuram sulphides, dithiophosphates are available in solid powder forms. However, it is a known shortcoming of these materials that they are extremely hygroscopic, and therefore challenging to handle in manufacturing processes. Examples of these accelerators include zinc dibenzyldithiocarbamate (ZBEC), zinc dialkyldithiophosphate (ZBOP), and tetrabenzyl thiuramdisulfide (TBzTD).

There is therefore a need for activators and accelerator materials for use in rubber vulcanization that is non-caustic, non-hygroscopic, and that is safe and convenient to handle in manufacturing.

It is an object of the invention to address at least some of the shortcomings of the prior art as discussed above.

### SUMMARY OF THE INVENTION

According to a first aspect to the present invention there is provided a composition suitable for use in the vulcanization of rubber comprising a salt of a vulcanization accelerator selected from a group of accelerator classes including thiazoles, dithiocarbamates, dithiophosphates, sulfenamides, thiuram sulfides, xanthates, guanidines, aldehyde amines, or combinations thereof; a solid particulate substrate; and a hydrophobic carrier material.

In one embodiment the composition comprises from about 5 to about 50 wt % of the salt of a vulcanization accelerator selected from a group of accelerator classes including thiazoles, dithiocarbamates, dithiophosphates, sulfenamides, thiuram sulfides, xanthates, guanidines, aldehyde amines or combinations thereof; from about 5 to about 40 wt % of the solid particulate substrate; and from about 10 to about 90 wt % of the hydrophobic carrier material.

In a preferred embodiment the solid particulate substrate is silica.

Preferably, the accelerator is selected from a group of accelerator classes including thiazoles, dithiocarbamates, dithiophosphates, thiuram sulphides, or combinations thereof.

More preferably, the salt of a vulcanization accelerator is a salt of 2-mercaptobezothiazole (MBT), zinc dibenzyldithiocarbamate (ZBEC), zinc dialkyldithiophosphate (ZBOP), tetrabenzyl thiuramdisulfide (TBzTD), or combinations thereof.

Most preferably, the salt is a sodium salt, potassium salt, ethanolamine salt, or combinations thereof.

The hydrophobic carrier material may be a wax, oil, rubber based polymer such as a cis-1,4-polyisoprene natural rubber or polybutadiene rubber, or combinations thereof.

In one embodiment the wax has a melting point of about 35 to about 70 deg C.

In a preferred embodiment the wax has a congealing point of above about 50 deg C.

In a particularly preferred embodiment the wax is a Fischer Tropsch wax.

The composition may be a solid at room temperature, preferably in the form of pellets.

According to a second aspect to the present invention there is provided a process for producing a composition suitable for use in the vulcanization of rubber, said process comprising the steps of a) providing an accelerator solution comprising a vulcanization accelerator selected from a group of accelerator classes including thiazoles, dithiocarbamates, dithiophosphates, sulfenamides, thiuram sulfides, xanthates, guanidines, and aldehyde amines; b) reacting the accelerator solution with a cation source containing cations for reacting with the vulcanization accelerator to form a reaction solution; c) adding a solid particulate substrate to the reaction solution; and d) adding a hydrophobic carrier material.

In one embodiment the process further comprises the step of heating the reaction solution after step (b).

In a preferred embodiment the process further comprises the step of heating the reaction solution containing the solid particulate substrate after step (c).

In a particularly preferred embodiment the process further comprises the step of heating the reaction solution containing the solid particulate substrate and the hydrophobic carrier material after step (d).

The process may further comprise the step of cooling the composition to a solid at room temperature and pelletizing the composition.

Preferably, in one embodiment of the process the composition comprises from about 5 to about 50 wt % of the salt of a vulcanization accelerator selected from a group of accelerator classes including thiazoles, dithiocarbamates, dithiophosphates, sulfenamides, thiuram sulfides, xanthates, guanidines, and aldehyde amines; from about 5 to about 40 wt % of the solid particulate substrate; and from about 10 to about 90 wt % the hydrophobic carrier material.

Preferably the solid particulate substrate is silica.

In one embodiment of the process the accelerator is selected from a group of accelerator classes including thiazoles, dithiocarbamates, dithiophosphates, and thiuram sulphides.

In a preferred embodiment of the process the salt of a vulcanization accelerator is a salt of 2-mercaptobezothiazole (MBT), zinc dibenzyldithiocarbamate (ZBEC), zinc dialkyldithiophosphate (ZBOP), or tetrabenzyl thiuramdisulfide (TBzTD).

In a particularly preferred embodiment of the process the salt is a sodium salt, potassium salt, or ethanolamine salt.

The hydrophobic carrier material may be a wax, oil, rubber based polymer such as a cis-1,4-polyisoprene natural rubber or polybutadiene rubber, or combinations thereof.

In one embodiment of the process the wax has a melting point of about 35 to about 70 deg C.

In a preferred embodiment of the process the wax has a congealing point above about 50 deg C.

In a particularly preferred embodiment of the process the wax is a Fischer Tropsch wax.

According to a third aspect to the present invention there is provided a method of processing a rubber composition containing at least one rubber containing olefinic unsaturation, the method comprising the step of contacting the rubber composition with a composition as described above.

### BRIEF DESCRIPTION OF THE DRAWINGS

The invention will now be described in more detail with reference to the following non-limiting embodiments and figures in which:

FIG. 1 shows a graphical comparison of the curing times using 1 phr and 2.5 phr embodiments of the invention;

FIG. 2 shows a graphical comparison of the rate of cure using 1 phr and 2.5 phr embodiments of the invention;

FIG. 3 shows a graphical comparison of the rheometry of different cations and compositions.

### DETAILED DESCRIPTION OF A PREFERRED EMBODIMENT

The present invention will now be described more fully hereinafter with reference to the accompanying figures, in which some of the non-limiting embodiments of the invention are shown.

The invention as described hereinafter should not be construed to be limited to the specific embodiments disclosed, with slight modifications and other embodiments intended to be included within the scope of the invention.

Although specific terms are employed herein, they are used in a generic and descriptive sense only and not for purposes of limitation.

As used herein, throughout this specification and in the claims which follow, the singular forms “a”, “an” and “the” include the plural form, unless the context clearly indicates otherwise.

The terminology and phraseology used herein is for the purpose of description and should not be regarded as limiting. The use of the terms “comprising”, “containing”, “having”, “including”, and variations thereof used herein, are meant to encompass the items listed thereafter, and equivalents thereof as well as additional items.

The present invention provides for a composition which is suitable for use in the process of rubber vulcanization.

The composition of the invention comprises a salt of a vulcanization accelerator selected from a group of accelerator classes including thiazoles, dithiocarbamates, dithiophosphates, sulfenamides, thiuram sulfides, xanthates, guanidines, aldehyde amines, or combinations thereof, a solid particulate substrate, and a hydrophobic carrier material.

It is envisaged that the composition, in particular the accelerator salt, or mixture of salts, can be tailored to the specific intended application and the required properties of the final product rubber composition.

The vulcanization accelerator component can be selected from any compound selected from the groups including thiazoles, dithiocarbamates, dithiophosphates, sulfenamides, thiuram sulfides, xanthates, guanidines, aldehyde amines. The accelerator salt component of the composition can be a combination of different salts of the same accelerator compound, or a combination of salts from different accelerator classes.

The accelerator salt may be a salt of an accelerator compound selected from the groups including thiazoles, dithiocarbamates, dithiophosphates, sulfenamides, thiuram sulfides, xanthates, guanidines, aldehyde amines, for example:

| Structure | Chemical name |
|---|---|
| 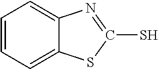 | mercapto- benzothiazole |
| 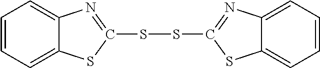 [SMILES: c1ccc2sc(SSc3nc4ccccc4s3)nc2c1] | dibenzthiazyl- disulfide |
| 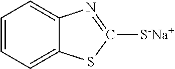 | sodium mercapto- benzothiazole |
| 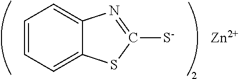 | zinc mercapto- benzothiazole |
| 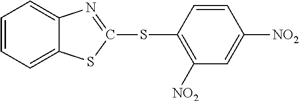 [SMILES: O=[N+]([O-])c1ccc(Sc2nc3ccccc3s2)c([N+](=O)[O-])c1] | 2,4-dinitrophenyl mercapto- benzothiazole |
| 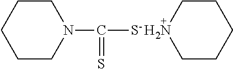 [SMILES: S=C([S-])N1CCCCC1 ; C1CCNCC1] | piperidine pentamethylene dithiocarbamate |
| 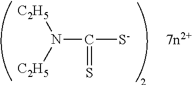 | zinc diethyl dithiocarbamate |
| 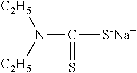 | sodium diethyl dithiocarbamate |
| 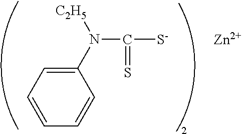 | zinc ethyl phenyl dithiocarbamate |
| 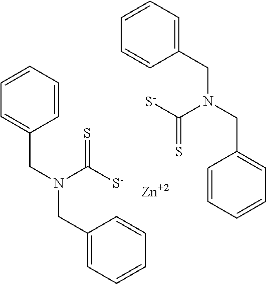 [SMILES: S=C([S-])N(Cc1ccccc1)Cc1ccccc1 ; S=C([S-])N(Cc1ccccc1)Cc1ccccc1 ; [Zn+2]] | zinc dibenzyl- dithio- carbamate (ZBEC) |
| NO the alkyl group is variable from | zinc dialkyl- |
| manufacture so is not exact. | dithio- |
| | phosphate |
| | (ZBOP) |
| 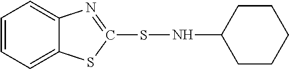 [SMILES: c1ccc2sc(SNC3CCCCC3)nc2c1] | N-cyclohexyl- benzthiazyl sulfenamide |
| 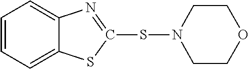 [SMILES: c1ccc2sc(SN3CCOCC3)nc2c1] | N-oxydiethyl- benzthiazyl sulfenamide |
| 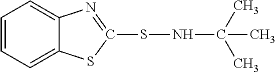 | N-t-butyl- benzthiazyl sulfenamide |
| 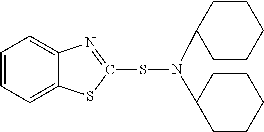 [SMILES: c1ccc2sc(SN(C3CCCCC3)C3CCCCC3)nc2c1] | N,N′-dicyclo- hexyl- benzhiazyl sulfenamide |
| 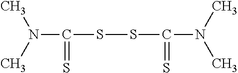 | tetramethyl thiuram disulfide |
| 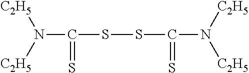 [SMILES: CCN(CC)C(=S)SSC(=S)N(CC)CC] | tetraethyl thiuram disulfide |
| 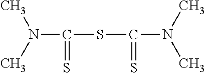 | tetramethyl thiuram monosulfide |
| 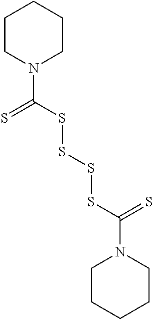 [SMILES: S=C(SSSSC(=S)N1CCCCC1)N1CCCCC1] | dipentamethyl- enethiuram tetrasulfate |
| 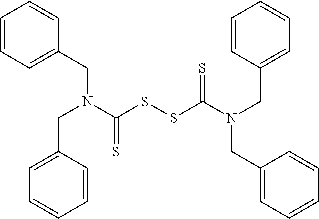 [SMILES: S=C(SSC(=S)N(Cc1ccccc1)Cc1ccccc1)N(Cc1ccccc1)Cc1ccccc1] | tetrabenzyl thiuram disulfide (TBzTD) |
| 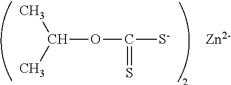 | zinc isopropyl xanthate |
| 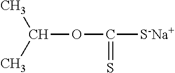 | sodium isopropyl xanthate |
| 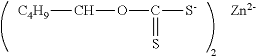 | zinc butyl xanthate |
| 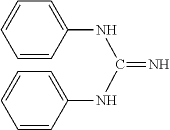 [SMILES: N=C(Nc1ccccc1)Nc1ccccc1] | diphenyl guanidine |
| 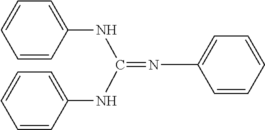 [SMILES: c1ccc(N=C(Nc2ccccc2)Nc2ccccc2)cc1] | triphenyl guanidine |
| 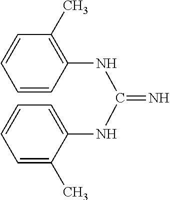 [SMILES: Cc1ccccc1NC(=N)Nc1ccccc1C] | di-o-tolyl guanidine |

The composition according to the present invention may be prepared by reacting the selected accelerator compound with a source of cations, for example, with a solution containing sodium, or potassium, or with liquid ethanolamine.

Any suitable source of cations may be used to stabilise the accelerator fragment. In a preferred embodiment of the invention the cation source is sodium hydroxide, potassium hydroxide or ethanolamine.

In one embodiment of the present invention, where the accelerator fragment is in the ZnX form, for example when X is dialkyldithiophosphate (i.e. ZBOP), dibenzyldithiocarbamate (i.e. ZBEC), or any other suitable accelerator fragment, a cation exchange process may be used to form the sodium, potassium, or ethanolamine salt.

In another embodiment of the present invention, for example, where the accelerator fragment is mercaptobenzothiazole, the cation source can be added directly to the accelerator fragment solution to form the salt of the selected accelerator fragment.

The reactions described above may be represented by the general reactions below. All these reactions are done stoichometrically, thereby compensating for polymer content where the accelerator fragment is polymer bound.

Cation+XMBT→Cation-MBT+H₂O

Cation+ZBEC→Cation-BEC+ZnO+H₂O

Cation+ZBOP→Cation-BOP+ZnO+H₂O

In accordance with the invention a solid particulate substrate is added to the cation-accelerator reaction solution. The solid particulate substrate should preferably have a particle size in the range of about 30 nm to 100 nm.

Suitable solid particulate substrates that may be used in the invention include silica, calcium carbonate or carbon black.

The solid particulate substrate may be selected from any solid material that does not react with the cation-accelerator solution. In a preferred embodiment of the invention silica is added as a solid particulate substrate to the cation-accelerator solution. The solid particulate substrate may also be formed in situ in the reaction of the accelerator starting material and the cation source.

Without thereby wishing to be bound by the confines of any particular theory, it is believed that the solid particular substrate acts as a low volume high surface area centre with the active cation accelerator species essentially surface coating it, at least partly. This then provides a good surface for the chemical reactions which will take place when the composition is used in the chemical vulcanization process.

A hydrophobic carrier material is added to the solid particulate substrate containing cation-accelerator solution. The hydrophobic carrier material may for example be a low melting point wax (melting point of 35 to 70 deg C). The hydrophobic carrier material typically has a congealing point above about 40 deg C, preferably above about 45 deg C, and even more preferably above about 50 deg C. In one embodiment of the invention the hydrophobic carrier material is a Fischer Tropsch wax. The solution is then solidified for further processing, such as pelletization. The Fischer Tropsch wax may be a wax product such as those available from Sasol® Wax, for example wax types 2396, 5592, and 1287.

The hydrophobic carrier material may also be an oil, or alternatively a hydrophobic polymeric material such as a rubber based polymer such as a cis-1,4-polyisoprene natural rubber (NR), polybutadiene rubber (BR), or any other hydrophobic carrier material, or combinations thereof, that would facilitate ease of use in further processing based on the particular intended downstream application. Oils of any suitable paraffinic type as used in normal rubber compounding will be suitable. For example, a wax or oil hydrophobic carrier material may be added to the solid particulate substrate containing cation-accelerator solution at a concentration of about 5 wt %, about 10 wt %, about 15 wt %, about 20 wt %, or any concentration in this range. This solution may then, in a further processing step, be incorporated into a further hydrophobic carrier such as cis-1,4-polyisoprene natural rubber (NR) or polybutadiene rubber (BR). In this case the wax or oil acts as a transfer carrier (protective carrier during production) prior to the addition into a suitable diene rubber carrier. In this example the hydrophobic actives may be extruded as a rubber pellets.

The use of SBR or NR of standard grades will provide suitable protection against atmospheric moisture. The use of low permeability butyl rubber can be used for longer storage period requirements. In one such example a salt of ZBEC is formulated in suitable solvent solution and is then dried onto silica in the presence of the wax carrier. This preparation is then introduced into a solid rubber using an internal mixer. The resultant material is extruded and used as a solid rubber additive for further addition into rubber compounds.

The invention as described creates a stabilised activator or accelerator composition that is non-caustic, non-hydroscopic, and that can be tailored to the specific rubber vulcanization system and the product properties required.

The composition of the present invention may be prepared by separately dissolving the selected vulcanization accelerator fragment and the selected cation source in suitable solvents. The solvents may be selected based on their ability to dissolve the accelerator fragment and the cation source, the miscibility of the solvents, and the ease with which these solvents can eventually be removed. In a preferred embodiment the solvent is an alcohol such as ethanol, preferably ethanol mixed with a further solvent such as dichloromethane.

The accelerator fragment solution and the cation source solution are then mixed for about 5 minutes. It is often the case that the basic solution facilitates the solubilisation of the accelerator in the reaction medium. The person skilled in the art will appreciate that the time required for mixing will vary depending on several factors such as the properties of the selected accelerator fragment and cation source, the solvent or solvent mixture used, and the temperature at which the reaction is performed.

The solid particulate substrate is then added to the reaction solution prepared from the vulcanization accelerator fragment and the cation source. The resultant mixture is then mixed until the solid particulate substrate has been wetted to a sufficient degree. The solution is then heated to near the boiling point of the particular solvent system, after which the hydrophobic carrier material is added to the mixture.

The solution comprising the hydrophobic carrier material is then heated to remove the selected solvent and any water formed in situ.

The composition is then cooled and processed further according to the needs of the particular application. The composition may for example be cooled and prepared for casting (flaking) or pelletizing.

The term “phr” as used herein, and according to conventional practice, refers to “parts by weight of a respective material per 100 parts by weight of rubber, or elastomer.”

The invention will now be described further by reference to the following non-limiting embodiments of the invention.

### Example 1: Sodium MBT in Fischer Tropsch Wax

An embodiment of the present invention was prepared by dissolving in a first vessel mercaptobenzothiazole as the selected accelerator in an ethanol and dicholormethane solvent mixture. A sodium hydroxide solution was separately prepared, as the selected source of cations, in pure ethanol. Dicholormethane was added to the accelerator dissolving solvent mixture to assist with the dissolution of mercaptobenzothiazole.

The two solutions were then mixed and heated at 39 deg C to remove the dichloromethane-ethanol azeotrope (solvent mixture composition of 95:5 in weight percentage dichloromethane). It will be appreciated by those persons skilled in the art that the duration and temperature for the azetrope removal process is linked to whether the process is conducted at atmospheric pressure, or under vacuum conditions.

Silica was added as the solid particulate substrate and the reaction solution containing the silica was mixed to wet the silica. The solution was then heated to near the boiling point of the ethanol (about 78 deg C).

Wax type 2396 from Sasol® which was added to the heated reaction solution. Other waxes, for example SRW and others has been shown to work identically, except for a change in the melting point of the particular wax used. The wax containing composition was then heated to remove all the ethanol, and the water formed during the reaction of the MBT solution and the NaOH solution, to form a sodium mercaptobenzothiazole containing wax composition. The wax composition was left to cool and solidify.

The following masses of material are prepared:

| | molar ratio | MW | mass (g) | |
|---|---|---|---|---|
| sodium hydroxide | 1 | 40 | 7.53 | |
| MBT | 1 | 167.24 | 31.47 | |
| Silica | — | — | 60.00 | |
| water formed | 1 | 18 | 3.39 | |
| in situ | | | | |
| | | Total | 0.096 | |
| Wax addition | | | 0.223 | kg |
| | | TOTAL | 0.319 | kg |

Ratios

| Component | Mass | Ratio (%) |
|---|---|---|
| NaOH | 7.53 | 2.42% |
| MBT | 31.47 | 10.11% |
| Silica | 60.00 | 19.28% |
| Wax | 223.096 | 71.69% |
| Water (lost) | 3.39 | 1.09% |
| Na-MBT | 35.61 | 11.17% |

This Na-MBT (11.17 wt %) wax composition was now tested in a standard rubber formulation of following composition:

| Masterbatch | phr |
|---|---|
| SBR 1502 | 80 |
| BR | 20 |
| N550 Carbon black | 80 |
| Hydrocarbon resin | 3 |
| 6-PPD | 5 |
| AntiOzonant wax | 2 |
| Stearic Acid | 2 |
| Total MB | 195 |

| | | NaMBT | NaMBT |
|---|---|---|---|
| | | (11.17%) | (11.17%) |
| | | activator wax | activator wax |
| Component | Control | 1 phr | 2.5 phr |
| CBS | 1.2 | 1.2 | 1.2 |
| S8 | 1.6 | 1.6 | 1.6 |
| ZnO | 1.0 | 1.0 | 1.0 |
| Na-MBT wax | 0.0 | 1.0 | 2.5 |

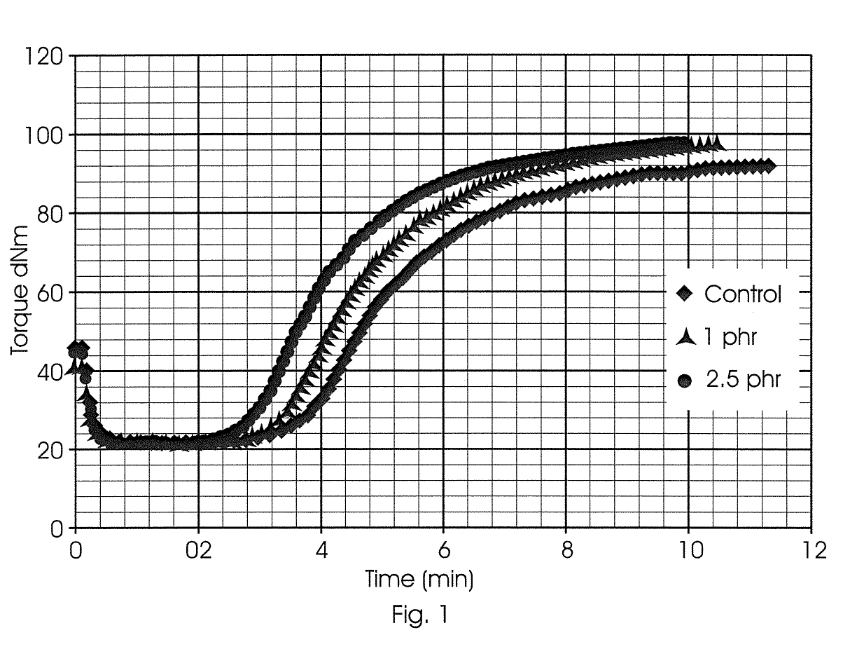

The results shown in FIGS. 1-3 were obtained and were determined using a rheometer (ODR or MDR).

Referring to FIG. 1, it is clear from a comparison of the graphs for the control sample, the 1 phr composition and the 2.5 phr composition that the addition of the Na-MBT wax composition (at only about 10 wt % active species) has a significant impact on the curing process. The effect of the Na-MBT wax composition used in the curing process is more evident in the rate of cure.

The t90 cure comparisons are provided in the table below:

| | Control | 1 phr | 2.5 phr |
|---|---|---|---|
| t90 | 100.00% | 95.65% | 81.29% |

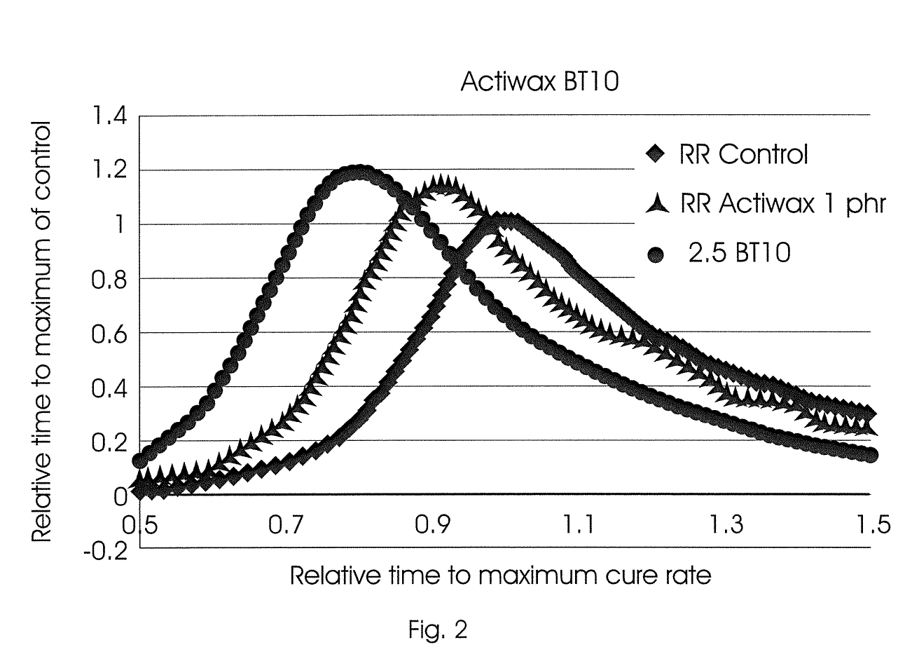

Furthermore, activation is shown by the effect on the rate of cure. As can be seen from FIG. 2, the Na-MBT wax composition increases maximum cure rate and time taken to reach that cure maxima is reduced.

### Example 2: Potassium MBT in Fischer Tropsch Wax

A composition according to the invention can also be prepared by the addition of potassium or ethanolamine to MBT. For certain applications it may be required to vary the actual amount of sodium-, potassium-, or ethanolamine-MBT in the final wax composition for different activities.

Thus, an embodiment of the present invention was prepared by dissolving in a first vessel mercaptobenzothiazole as the selected accelerator in an ethanol and dicholormethane solvent mixture. A potassium hydroxide solution was separately prepared, as the selected source of cations, in pure ethanol. Dicholormethane was added to the accelerator dissolving solvent mixture to assist with the dissolution of mercaptobenzothiazole.

The two solutions were then mixed and heated at 39 deg C to remove the dichloromethane-ethanol azeotrope (solvent mixture composition of 95:5 in weight percentage dichloromethane). The solutions were mixed under stirring in an open beaker. They were then transferred to a rotovap for solvent reclamation, and the addition of the silica and wax.

Silica was added as the solid particulate substrate and the reaction solution containing the silica was mixed to wet the silica. The solution was then heated to near the boiling point of the ethanol (about 78 deg C).

Wax type 2396 from Sasol® which was added to the heated reaction solution. The wax containing composition was then heated to remove all the ethanol, and the water formed during the reaction of the MBT solution and the KOH solution, to form a potassium mercaptobenzothiazole containing wax composition. The wax composition was left to cool and solidify.

The following masses of material are prepared:

| | molar ratio | MW | mass (g) | |
|---|---|---|---|---|
| potassium hydroxide | 1 | 56.4 | 56.4 | |
| MBT | 1 | 167.24 | 167.24 | |
| Silica | — | — | 555.23 | |
| water formed | 1 | 18 | 18.0 | |
| in situ | | | | |
| | | Total | 0.797 | |
| Wax addition | | | 1.269 | kg |
| | | TOTAL | 2.066 | kg |

Ratios

| Component | Mass | Ratio (%) |
|---|---|---|
| KOH | 56.40 | 2.73 |
| MBT | 167.24 | 8.09 |
| Silica | 555.23 | 26.87 |
| Wax | 1295.53 | 62.68 |
| Water (lost) | 18.0 | 0.87 |
| K-MBT | 206.34 | 9.98% |

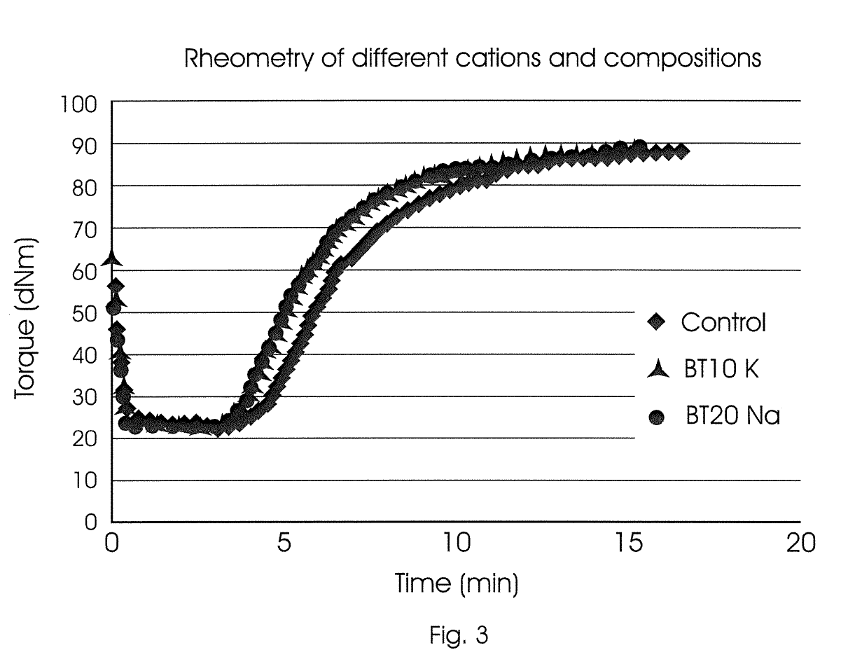

This K-MBT (9.98 wt %) wax composition was now tested in a standard rubber formulation as described above. FIG. 3 shows a graphical comparison of a 1 phr K-MBT (10 wt %) wax composition and 1 phr Na-MBT (20 wt %) wax composition.

The graph in FIG. 3 shows that 1 phr of both K-MBT (10 wt %) and Na-MBT (20 wt %) are active at the particular dosing and give at least a 10% improvement in cure rate as in FIG. 2. As expected, the Na-MBT (20 wt %) is slightly higher in activity as it has a higher active content.

### Example 3: Na-BEC, K-BEC and Ethanolamine-BEC in Fischer Tropsch Wax

An embodiment of the present invention was prepared for the zinc dibenzyldithiocarbamate (ZBEC) and tetrabenzyl thiuramdisulfide (TBzTD) type accelerator materials. In this instance some residual ZnO is formed in situ during the reaction of the zinc containing starting material.

Zinc dibenzyldithiocarbamate (ZBEC) was dissolved in an ethanol dicholormethane solvent mixture in a first vessel. Dicholormethane was added to the accelerator dissolving solvent mixture to assist with the dissolution of the ZBEC powder.

Ethanolamine is liquid while the other materials (Na, K) were provided as the solid hydroxides. It will be appreciated that the cation source can be provided in any form, with a suitable adjustment for the concentration thereof.

The accelerator fragment containing solution and the cation source solutions were then mixed for 5 minutes in an open beaker using magnetic stirring before being transferred to a rotovap for solvent removal and wax and silica addition. The mixture was heated at 39 deg C to remove the dichloromethane-ethanol azeotrope (solvent mixture composition of 95:5 in weight percentage dichloromethane).

Silica was added as the solid particulate substrate and the reaction solution containing the silica was mixed to wet the silica. The solution was then heated to near the boiling point of the ethanol (about 78 deg C).

It will be appreciated by those skilled in the art that ZnO will be formed in situ where a zinc containing accelerator starting material is used. With the mixing and solvent evaporation from the accelerator fragment solution and cation source solution a certain amount of the accelerator salt reaction product may be coated onto, or adsorb to the surface of the ZnO structures. In this way the in situ formed ZnO may participate as an solid particulate substrate, in addition to any added subtrates.

Wax type 2396 from Sasol® was added to the heated reaction solution. The wax containing composition was then heated to remove all the ethanol, and the water formed during the reaction of the ZBEC solution and the cation source solution, to form a salt-accelerator fragment containing wax composition.

The wax composition was left to cool and solidify.

The following stoichiometric reaction masses were used:

| Component | Na-BEC | K-BEC | Ethanolamine-BEC |
|---|---|---|---|
| Cation | 0.40 | 0.56 | 0.61 |
| ZBEC | 2.72 | 2.72 | 2.72 |
| Wax | 14.91 | 16.04 | 17.51 |
| Silica | 3.27 | 3.59 | 4.00 |

### Example 4: Na-BEC, K-BEC, Na-BOP and K-BOP in Fischer Tropsch Wax

Compositions were prepared using zinc dibenzyldithiocarbamate (ZBEC) and zinc dialkyldithiophosphate (ZBOP) as accelerator starting materials. As with all reactions according to the present invention using a Zn containing starting material, residual ZnO is formed in situ during the reaction of the zinc containing starting material. The so-formed ZnO may act as a solid particulate substrate in the further processing of the composition.

Zinc dibenzyldithiocarbamate (ZBEC) was dissolved in a suitable solvent mixture, for example Isopropyl alcohol (IPA) and water. A sufficient amount of HCl was added to dissolve the ZBEC material in the solvent system. The HCl was added into the solvent system at reasonable molarity range (0.2M to 5M).

HCl+ZBEC→ZnCl₂+H-BEC

The sodium and potassium cations were provided as the basic solutions of the hydroxides of these cations. It will be appreciated that the cation source can be provided in any form, with a suitable adjustment for the concentration thereof.

The accelerator fragment containing solution and the basic cation source solutions were then mixed for 5 minutes in an open beaker using magnetic stirring before being transferred to a rotovap for solvent removal and wax and silica addition.

It is proposed that the cation exchange reaction may proceed as follows:

ZnCl₂+3NaOH (or 3KOH)+2H-BEC ZnO+2NaBEC (or 2KBEC)+NaCl+H₂O

In an alternative embodiment, a small amount (about 10% of the molar concentration of the ZBEC or ZBOP starting material) zinc acetate and an excess base may be used to form a ZnO seeding reaction, i.e.:

Zn(Ac)₂+2NaOH (or KOH)→ZnO+2NaAc (or 2KAc)

The small amount of zinc acetate dissolved in solvent is added to the basic solution with the simulataneous addition of the accelerator fragment containing solution thereto.

Silica was added as the solid particulate substrate and the reaction solution containing the silica was mixed to wet the silica. The solution was then heated to near the boiling point of the IPA (about 82 deg C).

It will be appreciated by those skilled in the art that ZnO will be formed in situ where a zinc containing accelerator starting material is used. With the mixing and solvent evaporation from the accelerator fragment solution and cation source solution a certain amount of the accelerator salt reaction product may be coated onto, or adsorb to the surface of the ZnO structures. In this way the in situ formed ZnO may participate as an solid particulate substrate, in addition to any added subtrates.

Wax type 2396 from Sasol® was added to the heated reaction solution. The wax containing composition was then heated to remove all the IPA, and the water formed during the reaction of the ZBEC solution and the cation source solution, to form a salt-accelerator fragment containing wax composition.

The wax composition was left to cool and solidify.

Sodium and potassium salt accelerator materials where prepared in the same way using ZBOP as the accelerator starting material.

The following stoichiometric reaction masses were used (ZBEC):

| Component | Na-BEC | K-BEC |
|---|---|---|
| Cation | 88.0 | 123.4 |
| ZBEC | 610 | 610 |
| Wax | 4724.2 | 4982.5 |
| Silica | 590.5 | 622.8 |

The following stoichiometric reaction masses were used (ZBOP):

| Component | Na-BOP | K-BOP |
|---|---|---|
| Cation | 88.0 | 123.4 |
| ZBOP | 700 | 700 |
| Wax | 5248 | 5728 |
| Silica | 656 | 716 |

### Example 5: Potassium MBT in Wax/Rubber Carrier for Use as a Solid Rubber Additive for Further Addition into Rubber Compounds

| | | | % of |
|---|---|---|---|
| Raw material | Material Description | Mass (g) | total rubber |
| KOH Pellets | Spanish flakes of KOH | 75.36 | 3.0% |
| MBT Powder | Accelerator powder | 225.18 | 8.8% |
| Water of dilution | High molar KMBT | 76.25 | 3.0% |
| KMBT | Aqueous solution of KMBT | 300.00 | 11.7% |
| Water solution | Water in solution | 90.06 | 3.5% |
| Final Active | | 209.94 | 8.2% |
| Silica | | 209.00 | 8.2% |
| Wax | | 260.00 | 10.2% |
| Total mass (wet) | | 769.00 | 30.1% |
| Total mass (dry) | | 664.31 | 26.0% |
| Rubber addition | | 1889.47 | 74.0% |
| Compound total | | 2553.78 | 100.0% |

The above schema is an example of a KMBT accelerator synthesis dried onto silica powder in presence of wax carrier. The resultant material, once free of water (in this example), is then mixed into sufficient rubber to allow a total active content of about 11%.

The amount of silica is chosen such that the strength of the rubber is sufficient for extrusion capability.

1.-26. (canceled)

27. A composition suitable for use in the vulcanization of rubber comprising:
a) a salt of a vulcanization accelerator selected from a group of accelerator classes including thiazoles, dithiocarbamates, dithiophosphates, sulfenamides, thiuram sulfides, xanthates, guanidines, aldehyde amines, or combinations thereof;
b) a solid particulate substrate; and
c) a hydrophobic carrier material.

28. The composition according to claim 27, comprising:
a) from about 5 to about 50 wt % of the salt of a vulcanization accelerator selected from a group of accelerator classes including thiazoles, dithiocarbamates, dithiophosphates, sulfenamides, thiuram sulfides, xanthates, guanidines, aldehyde amines or combinations thereof;
b) from about 5 to about 40 wt % of the solid particulate substrate; and
c) from about 10 to about 90 wt % of the hydrophobic carrier material.

29. The composition according to claim 27, wherein the solid particulate substrate is silica.

30. The composition according to claim 27, wherein the accelerator is selected from a group of accelerator classes including thiazoles, dithiocarbamates, dithiophosphates, thiuram sulphides, or combinations thereof.

31. The composition according to claim 27, wherein the salt of a vulcanization accelerator is a salt of 2-mercaptobezothiazole (MBT), zinc dibenzyldithiocarbamate (ZBEC), zinc dialkyldithiophosphate (ZBOP), tetrabenzyl thiuramdisulfide (TBzTD), or combinations thereof.

32. The composition according to claim 27, wherein the salt is a sodium salt, potassium salt, ethanolamine salt, or combinations thereof.

33. The composition according to claim 27, wherein the hydrophobic carrier material is a wax, oil, rubber based polymer such as a cis-1,4-polyisoprene natural rubber or polybutadiene rubber, or combinations thereof.

34. The composition according to claim 33, wherein the wax has a melting point of about 35 to about 70 deg C.

35. The composition according to claim 33, wherein the wax has a congealing point of above about 50 deg C.

36. The composition according to claim 33, wherein the wax is a Fischer Tropsch wax.

37. The composition according to claim 27, wherein the composition is a solid at room temperature, preferably in the form of pellets.

38. A process for producing a composition suitable for use in the vulcanization of rubber, said process comprising the steps of:
a) providing an accelerator solution comprising a vulcanization accelerator selected from a group of accelerator classes including thiazoles, dithiocarbamates, dithiophosphates, sulfenamides, thiuram sulfides, xanthates, guanidines, and aldehyde amines;
b) reacting the accelerator solution with a cation solution containing cations for reacting with the vulcanization accelerator to form a reaction solution;
c) adding a solid particulate substrate to the reaction solution; and
d) adding a hydrophobic carrier material.

39. The process according to claim 38, further comprising the step of heating the reaction solution after step (b).

40. The process according to claim 38, further comprising the step of heating the reaction solution containing solid particulate substrate after step (c).

41. The process according to claim 38, further comprising the step of heating the reaction solution containing solid particulate substrate and the hydrophobic carrier material after step (d).

42. The process according to claim 38, further comprising the step of cooling the composition to a solid at room temperature and pelletizing the composition.

43. The process according to claim 38, wherein the composition comprises:
a) from about 5 to about 50 wt % of the salt of a vulcanization accelerator selected from a group of accelerator classes including thiazoles, dithiocarbamates, dithiophosphates, sulfenamides, thiuram sulfides, xanthates, guanidines, and aldehyde amines;
b) from about 5 to about 40 wt % of the solid particulate substrate; and
c) from about 10 to about 90 wt % a hydrophobic carrier material.

44. The process according to claim 38, wherein the solid particulate substrate is silica.

45. The process according to claim 38, wherein the accelerator is selected from a group of accelerator classes including thiazoles, dithiocarbamates, dithiophosphates, and thiuram sulphides.

46. The process according to claim 38, wherein the salt of a vulcanization accelerator is a salt of 2-mercaptobezothiazole (MBT), zinc dibenzyldithiocarbamate (ZBEC), zinc dialkyldithiophosphate (ZBOP), or tetrabenzyl thiuramdisulfide (TBzTD).

47. The process according to claim 38, wherein the salt is a sodium salt, potassium salt, or ethanolamine salt.

48. The process according to claim 38, wherein the hydrophobic carrier material is a wax, oil, rubber based polymer such as a cis-1,4-polyisoprene natural rubber or polybutadiene rubber, or combinations thereof.

49. The process according to claim 48, wherein the wax has a melting point of about 35 to about 70 deg C.

50. The process according to claim 48, wherein the wax has a congealing point above about 50 deg C.

51. The process according to claim 48, wherein the wax is a Fischer Tropsch wax.

52. A method of processing a rubber composition containing at least one rubber containing olefinic unsaturation, the method comprising the step of contacting the rubber composition with a composition according to claim 27.
